(19) United States
(12) Patent Application Publication
(10) Pub. No.: US 2010/0000071 A1
(43) Pub. Date: Jan. 7, 2010

(54) METHOD FOR CONSTRUCTING A MULTIPLE PIECE GOLF CLUB HEAD

(75) Inventor: Bradley C. Rice, Carlsbad, CA (US)

Correspondence Address: CALLAWAY GOLF C0MPANY, 2180 RUTHERFORD ROAD, CARLSBAD, CA, 92008-7328, US

(73) Assignee: CALLAWAY GOLF COMPANY, Carlsbad, CA (US)

(21) Appl. No.: 12/496,310

(22) Filed: Jul. 1, 2009

Related U.S. Application Data
(60) Provisional application No. 61/077,800, filed on Jul. 2, 2008.

(51) Int. Cl. B23P 11/00; B23P 17/04

(52) U.S. Cl. 29/525.14; 29/527.6

(57) ABSTRACT

A method for manufacturing a golf club head is disclosed herein. The method includes using four pieces to manufacture a golf club head with greater benefits than the prior art. The method includes tacking an aft-body to a face component prior to welding, and using 2-axis welding.

### CROSS REFERENCES TO RELATED APPLICATIONS

The Present Application claims priority to U.S. Provisional Patent Application No. 61/077,800 filed on Jul. 2, 2008.

### STATEMENT REGARDING FEDERALLY SPONSORED RESEARCH OR DEVELOPMENT

Not Applicable

### BACKGROUND OF THE INVENTION

1. Field of the Invention

The present invention relates to manufacturing golf club heads. More specifically, the present invention relates to manufacturing multiple piece golf club heads.

2. Description of the Related Art

Most conventional all metal golf club heads are manufactured using a cast titanium body with a sheet metal face insert. The major disadvantage of the cast face insert manufacturing method is the amount of casting stock that is wasted in casting a 460 cubic centimeters (“cc”) golf club head (as shown in FIG. 6), and the fact that the center of gravity (“CG”) consistency from the computer assisted drawing (“CAD”) to the finished part is poor.

Another process involves a forged face cup with a sheet metal crown, sheet metal sole and hosel tube. The major disadvantage of this process is the performance and controlling the volume near 460 cc may be difficult.

Some low quality drivers are composed of four pieces involving a sheet metal crown, sheet metal sole, sheet metal face and a hosel tube. The major disadvantage of this four piece method is the lower performance, lack of CG consistency, lack of characteristic time (“CT”), durability issues, and controlling the volume.

### BRIEF SUMMARY OF THE INVENTION

One aspect of the present invention is a method for manufacturing a golf club head. The method includes generating a CAD net size for the golf club head and the components of the golf club head. The components comprise a face component, a crown component, a sole component and a weight chip component. The method also includes forming the face component, the face component substantially matching the CAD net size. The face component comprises a striking plate portion, a return portion and a hosel having a bore. The method also includes reaming the bore of the hosel to ensure a predetermined loft angle and lie angle for the golf club head to create a reamed face component. The method also includes forming the crown component, the crown component substantially matching the CAD net size. The method also includes forming the sole component, the sole component substantially matching the CAD net size. The method also includes forming the weight chip component, the weight chip component substantially matching the CAD net size. The method also includes tacking the weight chip component to an internal surface of the sole component to create a tacked weight component. The method also includes welding the tacked weight component to the internal surface of the sole component to create a welded sole component. The method also includes tacking the crown component to the welded sole component to create tacked aft-body. The method also includes tacking the tacked aft-body to the reamed face component to create a tacked golf club head. The method also includes welding the tacked golf club head to create a welded golf club head. The method also includes grinding the welded golf club head to create a ground golf club head. The method also includes finishing the ground golf club head to create a finished golf club head.

Another aspect of the present invention is method for assembling a golf club head. The method includes providing a face component, a sole component and a crown component. The face component comprises a striking plate section, a return section and a hosel. The method also includes tacking the crown component to the sole component to create tacked aft-body. The method also includes tacking the tacked aft-body to the face component to create a tacked golf club head. The method also includes welding the tacked golf club head to create a welded golf club head.

The method disclosed reduces the cost of a large (near 460 cc) titanium driver-type golf club head without sacrificing performance and durability.

For example, casting a 460 cc driver body with very thin walls creates a lot of scrap titanium material. In a multi-piece format utilized in the method disclosed, the thin walls are created using sheet material and scrap is much less than a casting process. In a multi-piece format utilized in the method disclosed, a face component is preferably cast, however more face components are used on a single casting tree than entire 460 cc club head bodies. In alternative embodiments the face component is formed by forging or a pressed sheet metal.

Specific performance aspects are preferably managed through different features of the method disclosed.

CT and durability are preferably managed by utilizing a face component design that includes the face to body transition geometry (the portion of the body that transitions into the face around the face). CT is more consistent by not having the weld directly at the face to body transition as in a prior art four-piece construction. Durability is higher and more consistent for a similar reason as CT such as by positioning the weld area away from the high stresses of the face to body transition corner.

The volume of the golf club head is managed in multiple ways. One way is by ensuring that the body and face component are formed “net” to CAD without reverse engineering. The method disclosed has the body and face component fit to each other on every set of components without using the tacking and a manual fitting process currently used on conventional four-piece and forged face cup assembly processes.

Another manner in which the volume of the golf club head is managed is the very close fit of the components (precision trimmed parts), which preferably results in butt welds at all intersections. This allows joints to be welded without having them pull or distort during the heating and cooling of welding. Another manner in which the volume of the golf club head is managed is precisely forming the sheet metal parts, which allows the parts to be fit together prior to tacking them to the face component.

Welding consistency is another benefit from the sheet metal aft-body created by tacking the crown and sole together. Welding consistency is achieved since the weld joints are much more consistent than on manually fit crown to sole components. Weld consistency is key for numerous reasons including consistent joints that allow for semi or fully automated welding to be incorporated into the method.

The method allows for the butt joints to be welded using a plasma welding method or laser welding method which is typically easier to automate than conventional TIG welding. Automated plasma welding methods are generally faster than manual TIG welding, thus increasing throughput and potentially offering cost benefits. Consistent joints provide for more consistent welds, such that the added mass at the weld line is also easier to manage. The result of the method is a more consistent CG position of the golf club head than in conventional four-piece construction methods.

The method allows for face angle consistency to be managed without having to manually check and iterate the angle of the sole to the face or face component on each head. In a conventional four-piece construction and other face component assembly methods, the first two components combined are the face and the sole. The angle of the face to the sole then directly affects the face angle of the finished golf club head.

A resultant of forming well fitting, net components (face component, crown, and sole) is better management of the final CG positioning within a golf club head as compared to the original CAD data (specifically compared to cast body methods). The CG is managed by controlling the aft-body thickness. For the method, the crown and sole components are rolled to a tight tolerance prior to forming (+/−0.0015 inch). In conventional castings, there are many factors that will determine the ‘raw’ unfinished crown thickness such as actual tool fabrication, tool benching, tool to tool variation, shell expansion issues, shrink issues, and finishing. The fit management using precision trimmed and net components in the method provides CG management by ensuring the golf club head is not too large or small. Typically, a conventional casting requires more thickness removal during the finishing operations, which moves the CG more than using the method disclosed, especially with a grinding process that is not very tightly controlled for thickness and weight.

In the multi-piece construction method disclosed, the different components are preferably composed of different alloys. In a typical cast titanium body for a driver golf club head, there are very few alloys that can be used for casting. It is typical to use 6-4 titanium alloy since it has the appropriate strength characteristics and can be cast relatively thin. Thinner castings result in more issues with costly casting rejects, porosity, poor mold fill and the like. A sheet metal aft-body of the method disclosed allows the crown and sole components to be made from different alloys. The alloy choice is preferably made to manage different aspects such as cost, durability, performance and the like.

With high quality forming and precision sheet components, it is easier to achieve consistently thin crowns than in casting. Combined with alloy selection (using 15-3-3-3 alloy for the crown component), the crown component is greatly reduced in thickness compared to cast crowns. Further, the field durability of the crown component is increased with the method disclosed. The saved discretionary mass is used to specify the CG position, increase the moment of inertia (“MOI”) or both.

Substantially planar split lines are an important aspect of the preferred embodiment of the present invention. There are two preferred requirements for the multi-piece planar split line criteria. First, the crown to sole split line is planar wherever the crown and sole meet. Second, a major portion of the face cup to body split line is planar, and is preferably not planar around hosel area. The advantages to planar split lines are: 1) a manufacturing datum for an otherwise datum-less part; 2) easy to cut in 2-axis system; 3) easy to inspect, due to planar datum; and 4) welding automation can be done in a 2-axis system.

The precision trim portion preferably requires that the sheet metal parts are fabricated with an accurate edge condition that cannot be made by the normal “form +shear” process or from the “trim before form” process. The steps generally are as follows: 1) over form component (form component with enough extra material that a clean edge can be cut after forming); 2) fixture over formed component in accurate cutting fixture (this depends on cutting method); 3) cut component to final ‘net’ CAD size. The actual cutting method for the precision trimming can be done in many ways; in a press operation, with a mill, robotic laser cut, plasma cut, water jet cut, etc. The advantages of precision trimming are: 1) enables butt joints; and 2) creates consistency from part to part, which helps maintain basic dimensions like volume and face angle.

The butt joint combined with precision trimming and planar split lines us an important aspect of a preferred embodiment. The advantages of butt joints are as follows: 1) when combined with precision trimming, creates a very tight fitting, accurate joint around the entire head; 2) tight joints enable welding processes like plasma and laser that are more easily automated than a TIG process; 3) precise joints and better welding means that final mass properties will be better controlled in high volume production than with poor fitting and manual TIG welding process.

Single body for multiple lofts is a key concept, utilizing the same exact split lines for each head allows manufacturing and design flexibility. Many companies us the same sheet metal for multiple lofts, but they don't use the same split lines. 4-piece construction requires the face to tilt to accommodate loft adjustment. This is then compensated for in the body fit by either grinding the body to fit, for trimming the body differently by loft. The advantages of using a single body for multiple lofts: 1) if late in program a loft is added, the only a new face cup design is needed to be fabricated to get the new loft into the program; 2) body components can be run without knowing what exact loft the head will be until later in the process, which helps SKU and order management; 3) face cups can be used on multiple programs; 4) weld lines are the same for each loft, so when automating welding, only one program is needed for multiple lofts.

2-axis welding is a process that is enabled by the planar split lines. With the crown and sole split line being planar, automated welding becomes a very simple 2-axis system. Rotate the part on one axis (the rotation axis must be normal to the split plane). Then the torch (or head) only needs to move in one more axis to allow welding of the joint.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is an exploded view of a golf club head illustrating the body trim plane.

FIG. 2 is a top perspective view of a golf club head with the planar splint lines illustrated.

FIG. 3 is an isolated perspective view of a tacked body having a crown component tacked to a sole component with the trim plane illustrated.

FIG. 4 is an isolated view of a sole component of a golf club head illustrating a face to body trim plane and sole to crown trim plane.

FIG. 5 is an isolated view of a sole component of a golf club head illustrating with excess material removed.

FIG. 6 is an enlarged view of circle 6-7 of FIG. 8 prior to trimming.

FIG. 7 is an enlarged view of circle 6-7 of FIG. 8 subsequent to trimming.

FIG. 8 is a cross-sectional view along line 8-8 of FIG. 9 of a sole component of a golf club head.

FIG. 9 is a side view of a sole component of a golf club head.

FIG. 10 is a rear view of a tacked sole component to a crown component.

FIG. 11 is a cross-sectional view along line 11-11 of FIG. 10.

FIG. 12 is an enlarged view of circle 12 of FIG. 11 illustrating the precision trim surface of the butt joint which provides for a more accurate weld, volume and face angle.

FIG. 13 is an exploded perspective view of a body and face component with the face component having a loft of 12 degrees, lie of 57 degrees and a face angle of −1.0 degrees.

FIG. 14 is an isolated view of an alternative face component that can be used with the same body although this face component has a loft angle of 15.5 degrees, a 57 degrees lie angle and a face angle of −2.0 degrees.

FIG. 15 is a view of a face plate.

FIG. 16 is a cross-sectional view of a golf club head illustrating that all loft, lie, face angle, face progression, bulge, roll, and variable thickness can be set for each loft in the face component tooling.

FIG. 17 illustrates a welding of a body and the rotation axis.

FIG. 18 illustrates a welding of a body and a rotation axis.

FIG. 19 is a flow chart of a method.

FIG. 20 is a flow chart of a method.

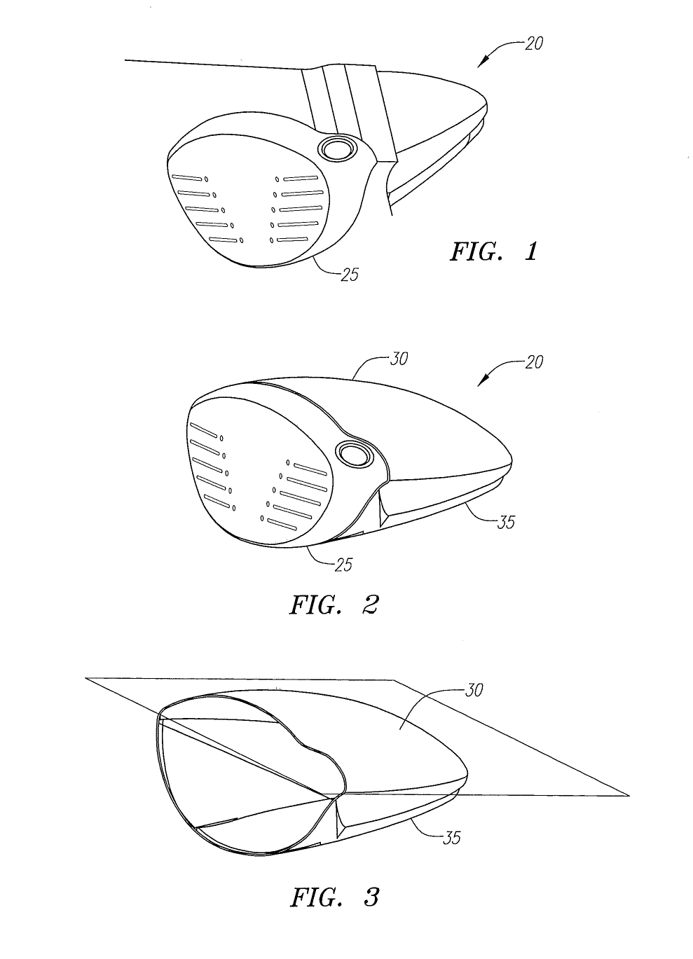

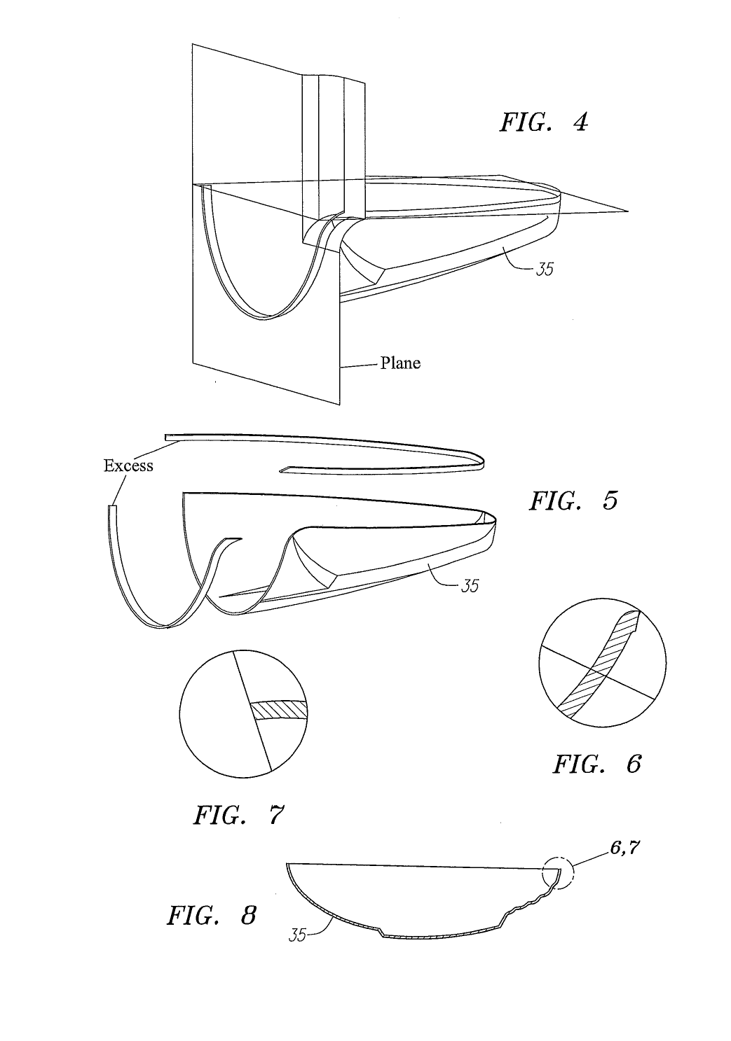

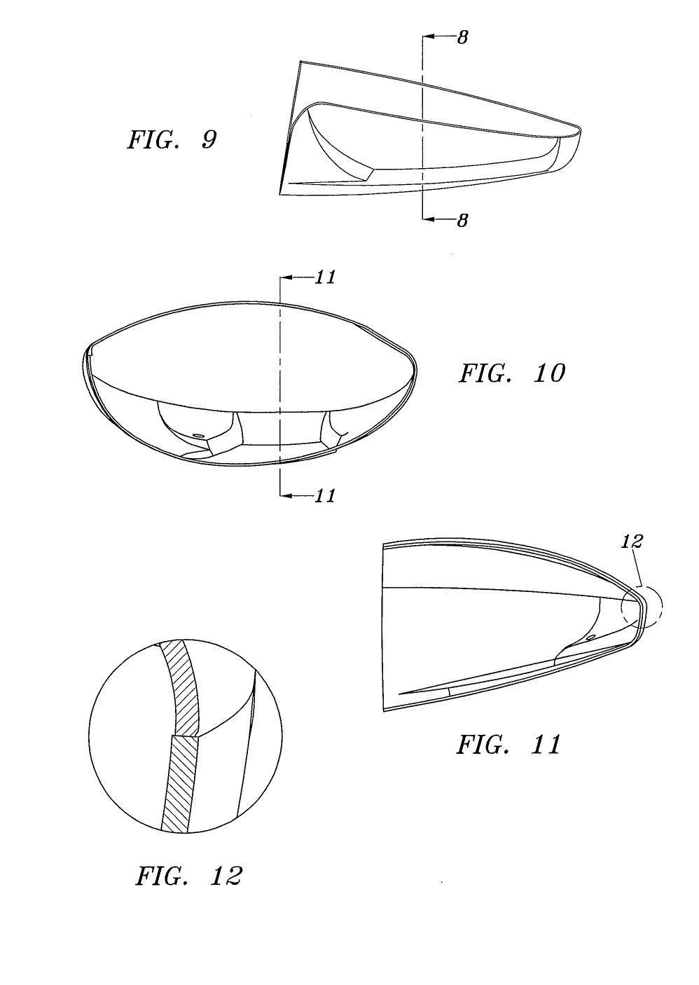

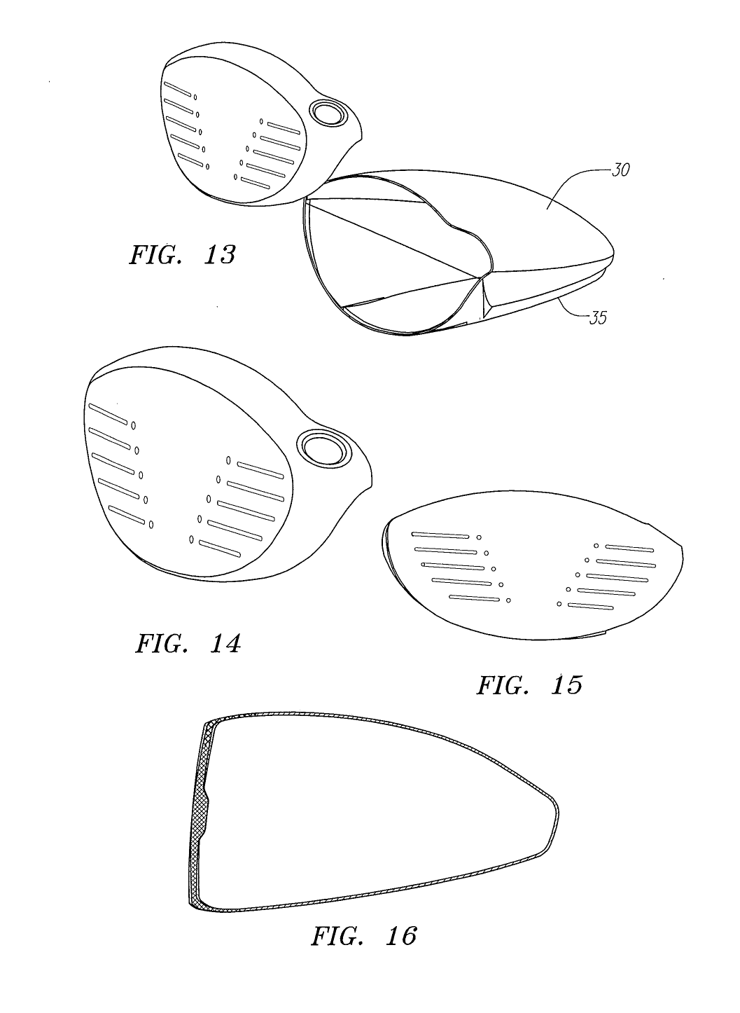

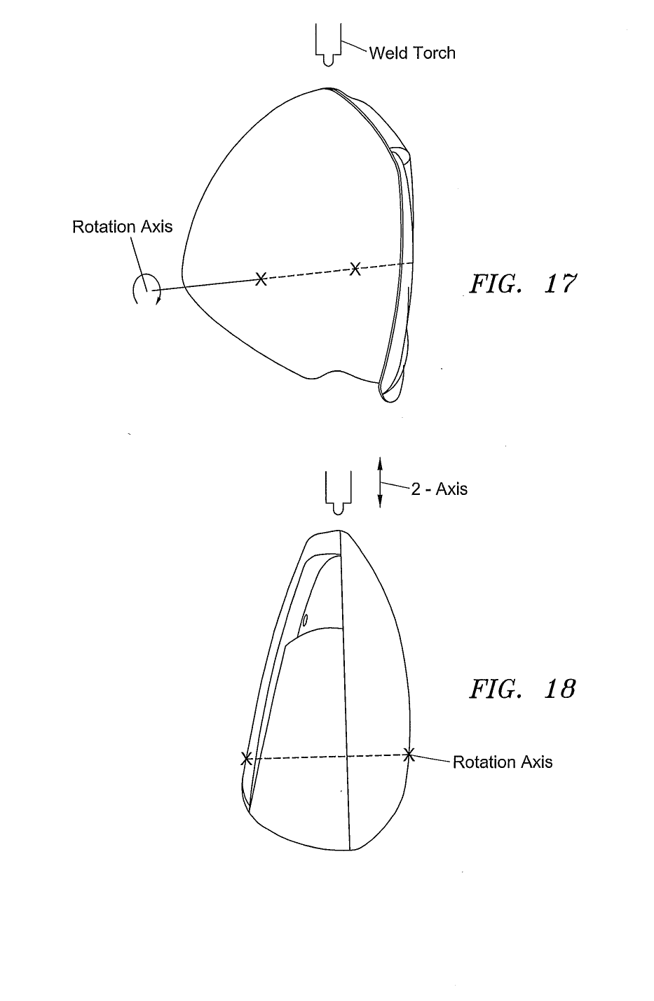

### DETAILED DESCRIPTION OF THE INVENTION

As shown in the figures, a golf club head 20 generally comprises a face component 25, a crown component 30, a sole component 35 and a weight chip component 40.

The golf club head 20, when designed as a driver, preferably has a volume from 200 cubic centimeters to 600 cubic centimeters, more preferably from 300 cubic centimeters to 500 cubic centimeters, and most preferably from 420 cubic centimeters to 470 cubic centimeters, with a most preferred volume of 460 cubic centimeters. The volume of the golf club head 20 will also vary between fairway woods (preferably ranging from 3-woods to eleven woods) with smaller volumes than drivers.

The golf club head 20, when designed as a driver, preferably has a mass no more than 215 grams, and most preferably a mass of 180 to 215 grams. When the golf club head 20 is designed as a fairway wood, the golf club head 20 preferably has a mass of 135 grams to 200 grams, and preferably from 140 grams to 165 grams.

The face component 25 is generally composed of a single piece of metal, and is preferably composed of a cast or coined metal material. More preferably, the cast or coined metal material is a titanium alloy material. Such titanium materials include titanium alloys such as 6-4 titanium alloy, SP-700 titanium alloy (available from Nippon Steel of Tokyo, Japan), DAT 55G titanium alloy available from Diado Steel of Tokyo, Japan, Ti 10-2-3 Beta-C titanium alloy available from RTI International Metals of Ohio, and the like. Other metals for the face component 25 include stainless steel, other high strength steel alloy metals and amorphous metals. Alternatively, the face component 25 is manufactured through forging, machining, powdered metal forming, metal-injection-molding, electro chemical milling, and the like.

The face component 25 generally includes a striking plate portion (also referred to herein as a face plate) and a return portion extending laterally inward from a perimeter of the striking plate portion. The striking plate portion typically has a plurality of scorelines thereon. The striking plate portion preferably has a thickness ranging from 0.010 inch to 0.250 inch, and the return portion preferably has a thickness ranging from 0.010 inch to 0.250 inch. The return portion preferably extends a distance ranging from 0.25 inch to 1.5 inches from the perimeter of the striking plate portion.

In a preferred embodiment, the return portion generally includes an upper lateral section, a lower lateral section, a heel lateral section and a toe lateral section. Thus, the return preferably encircles the striking plate portion a full 360 degrees. However, those skilled in the pertinent art will recognize that the return portion may only encompass a partial section of the striking plate portion such as 270 degrees or 180 degrees, and may also be discontinuous.

The upper lateral section preferably extends inward, towards the aft-body, a predetermined distance, d, to engage the crown. In a preferred embodiment, the predetermined distance ranges from 0.2 inch to 1.2 inch, more preferably 0.40 inch to 1.0 inch, and most preferably 0.8 inch, as measured from the perimeter of the striking plate portion to the rearward edge of the upper lateral section. In a preferred embodiment, the upper lateral section is substantially straight and substantially parallel to the striking plate portion from the heel end to the toe end. The perimeter of the striking plate portion is preferably defined as the transition point where the face component 25 transitions from a plane substantially parallel to the striking plate portion to a plane substantially perpendicular to the striking plate portion. Alternatively, one method for determining the transition point is to take a plane parallel to the striking plate portion and a plane perpendicular to the striking plate portion, and then take a plane at an angle of forty-five degrees to the parallel plane and the perpendicular plane. Where the forty-five degrees plane contacts the face component is the transition point thereby defining the perimeter of the striking plate portion.

The heel lateral section is substantially perpendicular to the striking plate portion and the heel lateral section preferably covers a portion of the hosel before engaging an optional ribbon section and a bottom section of the sole portion of the aft-body. The heel lateral section is attached to the sole portion, both the ribbon section and the bottom section. The heel lateral section extends inward a distance, d, from the perimeter a distance of 0.2 inch to 1.2 inch, more preferably 0.40 inch to 1.0 inch, and most preferably 0.8 inch. The heel lateral section is preferably straight at its edge.

At the other end of the face component 25 is the toe lateral section. The toe lateral section is preferably attached to the sole component 35. The toe lateral section extends inward a distance, d, from the perimeter a distance of 0.2 inch to 1.2 inch, more preferably 0.40 inch to 1.0 inch, and most preferably 0.8 inch. The toe lateral section preferably is preferably straight at its edge.

The lower lateral section extends inward, toward the aft-body, a distance, d, to engage the sole component 35. In a preferred embodiment, the distance d ranges from 0.2 inch to 1.2 inch, more preferably 0.40 inch to 1.0 inch, and most preferably 0.8 inch, as measured from the perimeter of the striking plate portion to the edge of the lower lateral section.

The face component preferably as a striking plate portion with varying thickness. In a preferred embodiment, the striking plate portion has a varying thickness such as described in U.S. Pat. No. 6,398,666, for a Golf Club Striking Plate With Variable Thickness, which pertinent parts are hereby incorporated by reference. Other alternative embodiments of the thickness of the striking plate portion are disclosed in U.S. Pat. No. 6,471,603, for a Contoured Golf Club Face and U.S. Pat. No. 6,368,234, for a Golf Club Striking Plate Having Elliptical Regions Of Thickness, which are both owned by Callaway Golf Company and which pertinent parts are hereby incorporated by reference. Alternatively, the striking plate portion has a uniform thickness.

Alternatively, the face component 25 is composed of an amorphous metal material such as disclosed in U.S. Pat. No. 6,471,604 which is hereby incorporated by reference in its entirety.

In a preferred embodiment, the golf club head 20 has a high coefficient of restitution thereby enabling for greater distance of a golf ball hit with the golf club. The coefficient of restitution (also referred to herein as “COR”) is determined by the following equation:

$$e = \frac{{v}_{2} - {v}_{1}}{{U}_{1} - {U}_{2}}$$

wherein U₁ is the club head velocity prior to impact; U₂ is the golf ball velocity prior to impact which is zero; v₁ is the club head velocity just after separation of the golf ball from the face of the club head; v₂ is the golf ball velocity just after separation of the golf ball from the face of the club head; and e is the coefficient of restitution between the golf ball and the club face.

The values of e are limited between zero and 1.0 for systems with no energy addition. The coefficient of restitution, e, for a material such as a soft clay or putty would be near zero, while for a perfectly elastic material, where no energy is lost as a result of deformation, the value of e would be 1.0. The present invention provides a club head having a coefficient of restitution ranging from 0.81 to 0.94, as measured under conventional test conditions.

The coefficient of restitution of the club head 20 under standard USGA test conditions with a given ball ranges from approximately 0.81 to 0.94, preferably ranges from 0.825 to 0.883 and is most preferably 0.845.

Additionally, the striking plate portion of the face component 25 has a more rectangular face providing a greater aspect ratio. The aspect ratio as used herein is defined as the width, “W”, of the face divided by the height, “H”, of the face. In one preferred embodiment, the width W is 100 millimeters and the height H is 56 millimeters giving an aspect ratio of 1.8. The striking plate portion of the present invention preferably has an aspect ratio that is greater than 1.8 for a club head having a volume greater than 420 cubic centimeters.

The face area of the striking plate portion preferably ranges from 5.00 square inches to 10.0 square inches, more preferably from 6.0 square inches to 9.5 square inches, and most preferably from 7.0 square inches to 9.0 square inches.

The axes of inertia are designated X, Y and Z. The X-axis extends from the striking plate portion through the center of gravity, CG, and to the rear of the golf club head 42. The Y-axis extends from the toe end of the golf club head 20 through the center of gravity, CG, and to the heel end of the golf club head 20. The Z-axis extends from the crown component 30 through the center of gravity, CG, and through the sole component 35.

As defined in Golf Club Design, Fitting, Alteration & Repair, 4^{th} Edition, by Ralph Maltby, the center of gravity, or center of mass, of the golf club head is a point inside of the club head determined by the vertical intersection of two or more points where the club head balances when suspended. A more thorough explanation of this definition of the center of gravity is provided in Golf Club Design, Fitting, Alteration & Repair.

The center of gravity and the moment of inertia of a golf club head 20 are preferably measured using a test frame (X^{T}, Y^{T}, Z^{T}), and then transformed to a head frame (X^{H}, Y^{H}, Z^{H}). The center of gravity of a golf club head may be obtained using a center of gravity table having two weight scales thereon, as disclosed in U.S. Pat. No. 6,607,452, entitled High Moment Of Inertia Composite Golf Club, and hereby incorporated by reference in its entirety. If a shaft is present, it is removed and replaced with a hosel cube that has a multitude of faces normal to the axes of the golf club head. Given the weight of the golf club head, the scales allow one to determine the weight distribution of the golf club head when the golf club head is placed on both scales simultaneously and weighed along a particular direction, the X, Y or Z direction. Those skilled in the pertinent art will recognize other methods to determine the center of gravity and moments of inertia of a golf club head.

In general, the moment of inertia, Izz, about the Z axis for the golf club head 20 of the present invention will range from 3500 g-cm² to 6000 g-cm², preferably from 4000 g-cm² to 5000 g-cm², and most preferably from 4200 g-cm² to 4750 g-cm². The moment of inertia, Iyy, about the Y axis for the golf club head 20 of the present invention will range from 2000 g-cm² to 4000 g-cm², preferably from 2500 g-cm² to 3500 g-cm², and most preferably from 2900 g-cm² to 3300 g-cm². The moment of inertia, Ixx, about the X axis for the golf club head 20 of the present invention will range from 2000 g-cm² to 4000 g-cm², preferably from 2500 g-cm² to 3750 g-cm², and most preferably from 3000 g-cm² to 3500 g-cm².

In general, the golf club head 20 has products of inertia such as disclosed in U.S. Pat. No. 6,425,832 which is hereby incorporated by reference in its entirety. Preferably, each of the products of inertia, Ixy, Ixz and Iyz, of the golf club head 20 have an absolute value less than 100 grams-centimeter squared. Alternatively, at least two of the products of inertia, Ixy, Ixz or Iyz, of the golf club head 20 have an absolute value less than 100 grams-centimeter squared.

Rice, U.S. patent application Ser. No. 12/475,036, filed May 29, 2009, for A Method For Constructing A Multiple Piece Golf Club Head is hereby incorporated by reference in its entirety.

In another embodiment, a face component, a crown component, a sole component and multiple weight chips are sized according to CAD dimensions. A bore is reamed to a predetermined loft. The weight chips are tacked to an internal portion of the sole component. The crown component is tacked to a sole component to form a body. The body is tacked to the face component. The components are welded together to form a welded golf club head. The welded golf club head is subjected to grinding to form a ground golf club head. The ground golf club head is then finished.

In an alternative embodiment, a face component is formed by welding a face cup to a hosel portion at a pre-set loft and lie. The face component, a crown component, a sole component and multiple weight chips are sized according to CAD dimensions. The weight chips are tacked to an internal portion of the sole component. The crown component is tacked to a sole component to form a body. The body is tacked to the face component. The components are welded together to form a welded golf club head. The welded golf club head is subjected to grinding to form a ground golf club head. The ground golf club head is then finished.

In an alternative embodiment, a face component, a crown component, a sole component and multiple weight chips are sized according to CAD dimensions. The crown component and the sole component are designed to have butt weld joints. A bore is reamed to a predetermined loft. The weight chips are tacked to an internal portion of the sole component. The crown component is tacked to a sole component to form a body. The body and the face component are designed to have butt weld joints. The body is tacked to the face component. The components are plasma welded together to form a welded golf club head. The welded golf club head is subjected to grinding to form a ground golf club head. The ground golf club head is then finished.

In an alternative embodiment, the crown component and the sole component have substantially planar split lines. Further the body and the face component have substantially planar split lines. The split lines make it easier to automate the manufacturing process since on a 2 axis system is needed in the planar weld area.

Further, exact same body components are preferably used for all lofts to reduce costs.

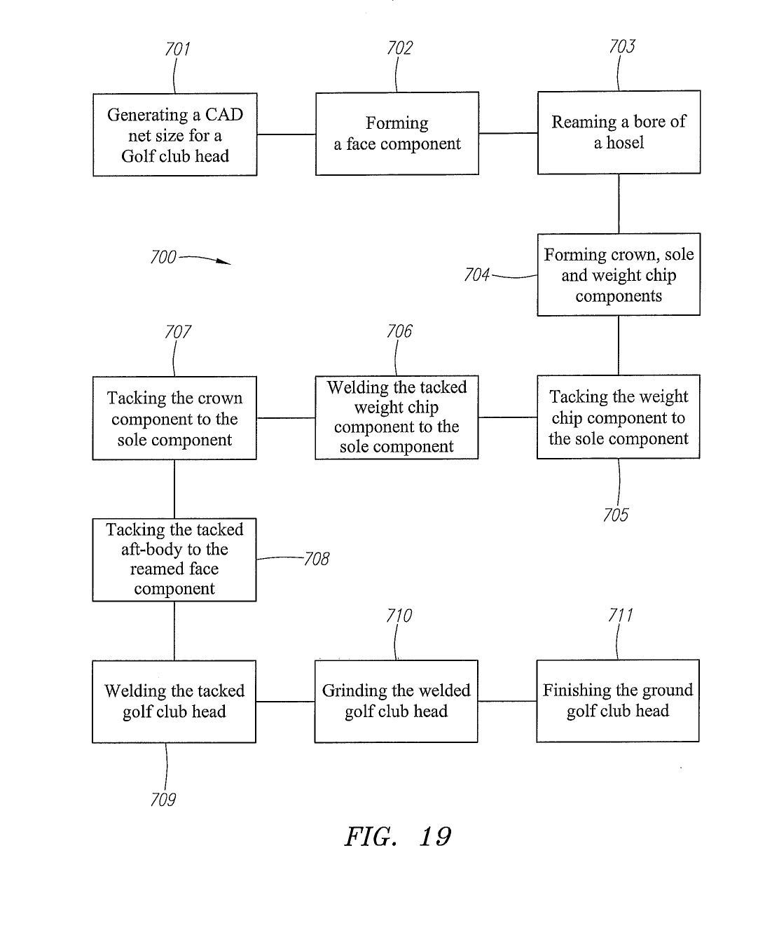

A specific method 700 for manufacturing a golf club head is shown in FIG. 19. At block 701, the method begins with generating a CAD net size for a golf club head and the components of the golf club head. The components include a face component, a crown component, a sole component and a weight chip component.

At block 702, the face component is formed. The face component substantially matches the CAD net size. The face component includes a striking plate portion, a return portion and a hosel having a bore.

At block 703, the bore of the hosel is reamed to ensure a predetermined loft angle and lie angle for the golf club head, resulting in a reamed face component.

At block 704, the crown component, the sole component and the weight component are formed. Each of the crown component and the sole component substantially matches the CAD net size. For example, the crown and sole components may be formed from a sheet of titanium material that is first rolled to a tight tolerance (+/−0.0015 inch) prior to forming. The formed components are precision trimmed, and the net components help tighten any variation in the resulting golf club head's center of gravity from the CAD specifications. The weight chip component also substantially matches the CAD net size.

At block 705, the weight chip component is tacked to an internal surface of the sole component to create a tacked weight component, as shown in FIG. 2.

At block 706, the tacked weight component is welded to the internal surface of the sole component to create a welded sole component.

At block 707, the crown component is tacked to the welded sole component to create tacked aft-body, as shown in FIG. 3.

At block 708, the tacked aft-body is tacked to the reamed face component to create a tacked golf club head.

At block 709, the tacked golf club head is welded to create a welded golf club head.

At block 710, the welded golf club head is ground to create a ground golf club head.

At block 711, the ground golf club head is finished to create a finished golf club head.

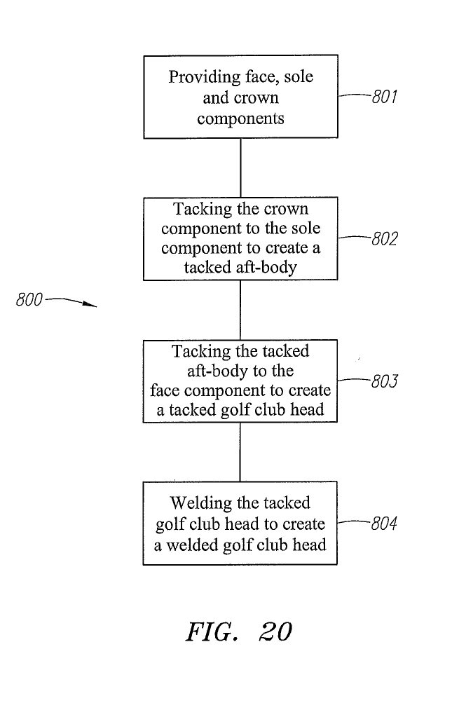

A flow chart for a general method 800 for assembling a golf club head is shown FIG. 20. At block 801, a face component, a sole component and a crown component are provided for assembly. The face component includes a striking plate section, a return section and a hosel. Each of these components is preferably made to net to its CAD specifications, so that any grinding, bending or tweaking of the components to get them to fit together is eliminated.

At block 802, the crown component is tacked to the sole component to create tacked aft-body.

At block 803, the tacked aft-body is tacked to the face component to create a tacked golf club head.

At block 804, the tacked golf club head is welded to create a welded golf club head.

Each of the components preferably is composed of titanium alloy. More specifically, the face component is preferably composed of cast titanium alloy. The sole component and the crown component are preferably composed of a sheet-formed titanium alloy.

Alternatively, the face component is preferably composed of coined titanium alloy. The sole component and the crown component are preferably composed of a sheet-formed titanium alloy.

Alternatively, the face component is preferably composed of forged titanium alloy. The sole component and the crown component are preferably composed of a sheet-formed titanium alloy.

The finished golf club head preferably has a volume ranging from 450 cc to 475 cc, and more preferably from 455 cc to 465 cc. The finished golf club head preferably has a mass ranging from 175 grams to 224 grams, and more preferably from 190 grams to 210 grams. The weight chip component preferably has a mass ranging from 5 grams to 30 grams.

The finished golf club head preferably has a moment of inertia, Iyy, about the center of gravity of the finished golf club head greater than 2000 grams-centimeters squared and a moment of inertia, Izz, about the center of gravity of the finished golf club head greater than 3000 grams-centimeters squared.

More preferably, the finished golf club head has a moment of inertia, Iyy, about the center of gravity of the finished golf club head greater than 2000 grams-centimeters squared and a moment of inertia, Izz, about the center of gravity of the finished golf club head greater than 4000 grams-centimeters squared.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

I claim as my invention the following:

1. A method for manufacturing a golf club head, the method comprising:
generating a CAD net size for the golf club head and the components of the golf club head, the components comprising a face component, a crown component, a sole component and a weight chip component;
forming the face component, the face component substantially matching the CAD net size, the face component comprising a striking plate portion, a return portion and a hosel having a bore;
reaming the bore of the hosel to ensure a predetermined loft angle and lie angle for the golf club head to create a reamed face component;
forming the crown component, the crown component substantially matching the CAD net size;
forming the sole component, the sole component substantially matching the CAD net size;
forming the weight chip component, the weight chip component substantially matching the CAD net size;
tacking the weight chip component to an internal surface of the sole component to create a tacked weight component;
welding the tacked weight component to the internal surface of the sole component to create a welded sole component;
tacking the crown component to the welded sole component to create tacked aft-body;
tacking the tacked aft-body to the reamed face component to create a tacked golf club head;
utilizing 2-axis welding to weld the tacked golf club head to create a welded golf club head;
grinding the welded golf club head to create a ground golf club head; and
finishing the ground golf club head to create a finished golf club head.

2. The method according to claim 1 wherein each of the components of the golf club head are composed of a titanium alloy.

3. The method according to claim 1 wherein the face component is composed of a cast titanium alloy material, the sole component is composed of a sheet-formed titanium alloy material, and the crown component is composed of a sheet-formed titanium alloy material.

4. The method according to claim 1 wherein the face component is composed of a coined titanium alloy material, the sole component is composed of a sheet-formed titanium alloy material, and the crown component is composed of a sheet-formed titanium alloy material.

5. The method according to claim 1 wherein the face component is composed of a forged titanium alloy material, the sole component is composed of a sheet-formed titanium alloy material, and the crown component is composed of a sheet-formed titanium alloy material.

6. The method according to claim 1 wherein forming the crown component comprises cutting a sheet to a forming size crown component having a length greater than the CAD net size, and trimming the forming size crown component to substantially match the CAD net size crown component.

7. The method according to claim 1 wherein forming the sole component comprises cutting a sheet to a forming size sole component having a length greater than the CAD net size, and trimming the forming size sole component to substantially match the CAD net size sole component.

8. The method according to claim 1 wherein the finished golf club head has a volume ranging from 450 cc to 475 cc.

9. The method according to claim 1 wherein the finished golf club head has a mass ranging from 175 grams to 225 grams.

10. The method according to claim 1 wherein the finished golf club head has a mass ranging from 190 grams to 210 grams.

11. The method according to claim 1 wherein the finished golf club head has a volume ranging from 455 cc to 465 cc.

12. The method according to claim 1 wherein the finished golf club head has a moment of inertia, Iyy, about the center of gravity of the finished golf club head greater than 2000 grams-centimeters squared and a moment of inertia, Izz, about the center of gravity of the finished golf club head greater than 3000 grams-centimeters squared.

13. The method according to claim 1 wherein the finished golf club head has a moment of inertia, Iyy, about the center of gravity of the finished golf club head greater than 2000 grams-centimeters squared and a moment of inertia, Izz, about the center of gravity of the finished golf club head greater than 4000 grams-centimeters squared.

14. The method according to claim 1 wherein the weight chip component has a mass ranging from 5 grams to 30 grams.

15. A method for assembling a golf club head, the method comprising:
providing a face component, a sole component and a crown component, the face component comprising a striking plate section, a return section and a hosel;
tacking the crown component to the sole component to create tacked aft-body;
tacking the tacked aft-body to the face component to create a tacked golf club head; and
welding the tacked golf club head by using 2-axis welding to create a welded golf club head.

16. The method according to claim 15 further comprising finishing the welded golf club head to create a finished golf club head.

17. The method according to claim 15 wherein each of the components of the golf club head are composed of a titanium alloy.

18. The method according to claim 15 wherein the face component is composed of a cast titanium alloy material, the sole component is composed of a sheet-formed titanium alloy material, and the crown component is composed of a sheet-formed titanium alloy material.

19. The method according to claim 15 wherein the face component is composed of a coined titanium alloy material, the sole component is composed of a sheet-formed titanium alloy material, and the crown component is composed of a sheet-formed titanium alloy material.

20. The method according to claim 15 wherein the face component is composed of a forged titanium alloy material, the sole component is composed of a sheet-formed titanium alloy material, and the crown component is composed of a sheet-formed titanium alloy material.
